(19) United States
(12) Patent Application Publication
(10) Pub. No.: US 2011/0021125 A1
(43) Pub. Date: Jan. 27, 2011

(54) Poultry processing system

(76) Inventors: George Massey, Starr, SC (US); Wesley Massey, Starr, SC (US)

Correspondence Address: J. BENNETT MULLINAX, LLC, P. O. BOX 26029, GREENVILLE, SC, 29616-1029, US

(21) Appl. No.: 12/806,195

(22) Filed: Apr. 24, 2009

(51) Int. Cl. A22C 21/00

(52) U.S. Cl. 452/150; 452/177

(57) ABSTRACT

A system for processing meat is provided. The system includes a conveyor that carries a food holder through a pivoting engagement. The food holder defines a first cutting groove and a second cutting groove that intersect one another. Automatic cutting blades are configured for being at least partially received within the first and second cutting grooves in order to automatically cut meat carried by the food holder. The food holder is configured for being positioned with respect to the conveyor so that the first automatic cutting blade can be aligned with the first cutting groove and so that the second automatic cutting blade can be aligned with the second cutting groove.

### FIELD OF THE INVENTION

The present invention relates generally to poultry processing. More particularly, the present application involves a poultry processing system that may be capable of automatically processing chicken tenders without need for manual cutting thereof.

### BACKGROUND

Poultry processing systems are known for use in the production and packaging of poultry. Certain types of these systems employ a conveyor belt that is used to transfer the poultry carcasses to different stations for processing. The conveyor is typically formed from a series of rigid, interlocking segments that form a continuous conveyor platform. The connection between the interlocking segments may be effected through use of a pin that allows the segments to enjoy a degree of movement relative to one another. The pin connection may be made in such a manner that the connected segments may be laterally movable with respect to one another so that the conveyor platform can negotiate curves as well as being capable of being directed vertically up or down.

Deboning horns are attached to the conveyor platform and extend vertically upwards. The deboning horns are generally made of stainless steel or plastic and have a conical shape. The poultry carcasses are placed onto the deboning horns and transferred from station to station along the track of the conveyor platform for processing thereof. A worker will manually apply a cutting blade to the poultry carcass at each station in order to remove a desired portion of the poultry carcass or to perform some other operation thereon. The deboning horns may be mounted to the conveyor platform so that they can rotate freely thereon so that the poultry carcasses can be turned or otherwise adjusted upon entering various processing stations. Application of a cutting blade to a poultry carcass that is supported by a freely rotating deboning horn may cause the carcass to move away from the cutting edge of the blade because the proper resistance to the cutting force is not present.

Other systems are known in which a platform for holding a specific part of the poultry carcass is carried by the conveyor platform. For example, the platform can have a depression therein for receiving a poultry tender or a poultry breast. The platform may be rigid so that it does not rotate with respect to the conveyor platform in order to assist a worker in manually cutting portions of the specific part. Although capable of preparing a poultry product as desired, such systems require intensive labor and increased expense. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 a top view of a food holder in accordance with one exemplary embodiment.

FIG. 2 is a back view of the food holder of FIG. 1.

FIG. 3 is a side view of the food holder of FIG. 1.

FIG. 4 is a front view of a processing system in accordance with one exemplary embodiment.

FIGS. 5A and 5B combined show a top view of the system of FIG. 4 in accordance with one exemplary embodiment with a cover removed in order to illustrate various components of the system.

FIG. 6 is a side view of a segment of a conveyor in accordance with one exemplary embodiment.

FIG. 7 is a perspective view of the segment of FIG. 6.

FIG. 8 is a top view of an alternative exemplary embodiment of a processing system.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a processing system 10 capable of performing various processing functions to meat 66 in an automated fashion that requires minimum or zero human involvement. The system 10 employs a conveyor 14 that is capable of transporting meat 66, for example poultry, to various stations 86 and 88 that function to cut the meat 66 in a desired manner. When used in conjunction with the processing of rib meat from a chicken, portions of the meat 66, such as fat, may be automatically cut and removed at the first cutting station 86 so that only the chicken tenders 66 remain on the conveyor 14. Subsequently, the chicken tenders 66 can be transferred to the second cutting station 88 so that so that the resulting chicken tenders 66 can be automatically cut into a desired size and may be removed from the conveyor 14 through by way of air jets or a cyclone for subsequent packaging. The system 10 thus provides a degree of automation to the processing of meat 66. Although capable of processing various types of meat 66, for purposes of illustration the present system 10 will be discussed with regard to the processing of poultry, and specifically with the processing of chicken tenders 66 of poultry. However, it is to be understood that the system 10 is not limited to the processing of poultry and chicken tenders 66 and may be used in order to process other portions of poultry or may be used in the processing of beef, pork, fish or other food items.

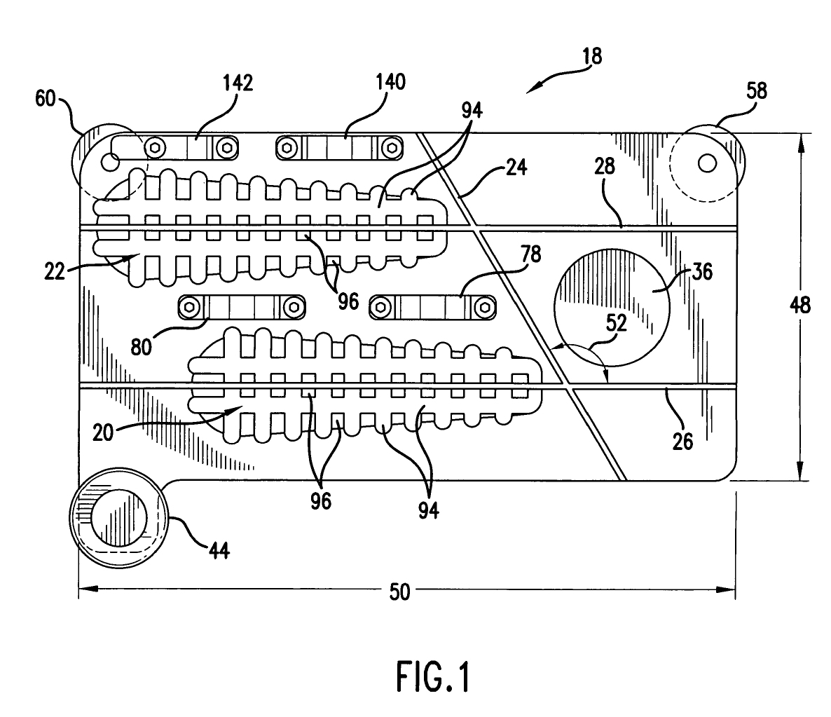

FIG. 1 is a top view of a food holder 18 used in accordance with one exemplary embodiment. The food holder 18 is provided in order to hold and carry meat 66 to the various cutting stations 86 and 88. The food holder 18 may be made out of hard plastic in accordance with certain embodiments so that it may be bleached or otherwise cleaned and sterilized as necessary due to its contact with food products. The food holder 18 can be designed specifically for the type of meat 66 that is being processed. For example, the food holder 18 may have a top surface that defines a first meat depression 20 and a second meat depression 22 thereon. The meat depressions 20 and 22 can be shaped and sized so as to be capable of receiving meat 66 products that are chicken tenders 66. Each of the meat depressions 20 and 22 can be provided with a series of grooves 94 and projections 96. The projections 96 extend above the grooves 94. The projections 96 help to hold the chicken tenders 66 during the cutting process and the grooves 94 may help to release the chicken tenders 66 after the cutting process. However, it is to be understood that the grooves 94 and projections 96 need not be present in accordance with other exemplary embodiments.

The food holder 18 has a first cutting groove 24 that extends down from its top surface. The first cutting groove 24 extends substantially across the width 48 of the food holder 18 as illustrated in FIG. 1. A second cutting groove 26 is also defined from the top surface of the food holder 18 downward into a portion of its depth. The second cutting groove 26 extends across substantially the entire length 50 of the food holder 18. The second cutting groove 26 extends through the midpoint of the first meat depression 20 and may be at least partially defined at the bottom of the first meat depression 20. The food holder 18 also defines a third cutting groove 28 that extends from the upper surface of the food holder 18 to a predetermined depth. The third cutting groove 28 may be parallel to the second cutting groove 26 and may extend across substantially the entire length 50 of the food holder 18. The third cutting groove 28 extends through the midpoint of the second meat depression 22 and may be defined on the bottom of the second meat depression 22.

The first cutting groove 24 is present to allow the chicken tenders 66 to be cut to a desired length and may be oriented at an angle 52 to both the second cutting groove 26 and the third cutting groove 28. The first cutting groove 24 thus intersects both the second and third cutting grooves 26 and 28 at an identical angle 52. Angle 52 may be greater than ninety degrees in accordance with certain exemplary embodiments. As such, the first cutting groove 24 may be non-perpendicular to the second cutting groove 26 and the third cutting groove 28 in accordance with certain exemplary embodiments. Although described as having a single first cutting groove 24, it is to be understood that multiple first cutting grooves 24 can be included so that the chicken tenders 66 can be cut multiple times. For example, it may be desired to cut the chicken tenders 66 into chicken nuggets and multiple first cutting grooves 24 can be located on the food holder 18 to allow the chicken tenders 66 to be cut multiple times. Further, although shown as having a single second cutting groove 26 and a single third cutting groove 28, it is to be understood that any number of second cutting grooves 26 and third cutting grooves 28 may be present in order to cut the chicken tenders 66 any desired number of times.

Angle 52 may be from ninety five degrees to one hundred and forty degrees in accordance with certain exemplary embodiments. The first cutting groove 24 does not intersect the first meat depression 20 or the second meat depression 22. However, it is to be understood that other exemplary embodiments are possible in which the first cutting groove 24 does intersect the first meat depression 20 and/or the second meat depression 22. Further, the food holder 18 along with the meat depressions 20 and/or 22 can be variously configured in accordance with other exemplary embodiments to hold different types and sizes of meat 66.

The food holder 18 has a first cam 78, second cam 80, third cam 140 and fourth cam 142 located on its upper surface. The cams 78, 80, 140 and 142 are offset from one another along the length 50 of the food holder 18 such that their respective raised portions are not aligned with one another along the length 50 of the food holder 18. The cams 78, 80, 140 and 142 are used for sensing the position of the food holder 18 by the system 10 as will be discussed to aid in removal of the meat 66 on the food holder 18 by way of air jets or a cyclone. Other exemplary embodiments are possible in which the cams 78, 80, 140 and 142 are not present or are variously configured. The food holder 18 also includes a pivot pin 36 that functions to pivotally connect the food holder 18 to the conveyor 14. As such, the food holder 18 is capable of pivoting with respect to the conveyor 14 about the axis of the pivot pin 36 so that its relative position thereto can be adjusted. Also included on the food holder 18 is a guide wheel 44. The guide wheel 44 rotates about an axis that extends in the height direction of the food holder 18. Side rollers 58 and 60 are also included on the food holder 18 and extend from the side thereof. Side roller 58 may be present in order to index the food holder 18 to a desired angle. Side roller 60 may function to help hold the food holder 18 in a straight configuration in accordance with certain exemplary embodiments. The side rollers rotate about an axis that is parallel to the axis about which the guide wheel 44 rotates. The side roller 60 and the guide wheel 44 may work together in a cam to establish a preferred angle of orientation of the food holder 18.

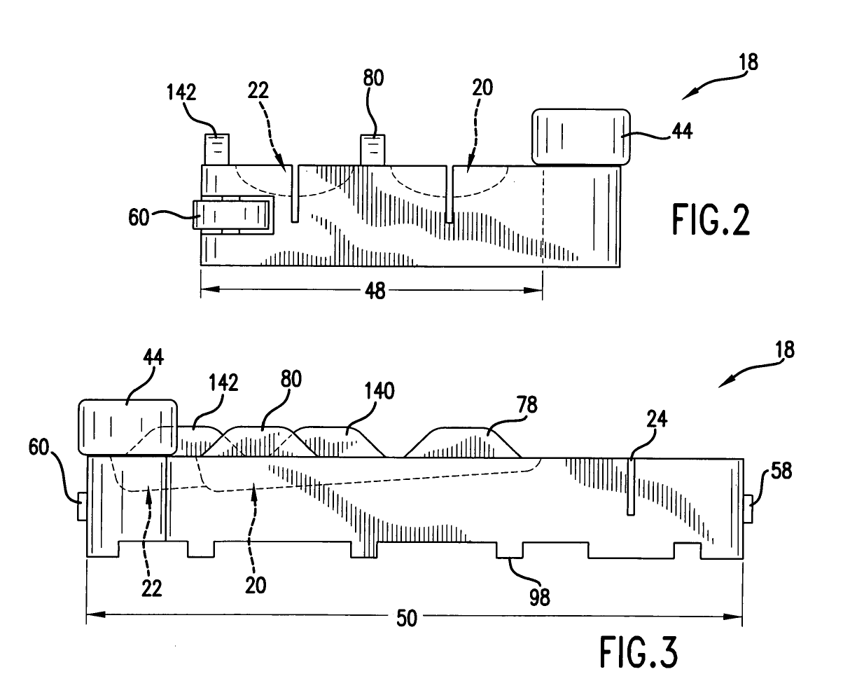

FIG. 2 is a back view of the food holder 18 of FIG. 1. This view shows the extension of the side roller 60 and the guide wheel 44 from the top upper surface of the food holder 18 such that the side roller 60 and guide wheel 44 are located at completely opposite sides along the width 48 of the food holder 18. The guide wheel 44 is located above the upper surface of the food holder 18 in order to help feed the food holder 18 through the cam. The side roller 60 is located a distance below the upper surface of the food holder 18. The second cutting groove 26 and the third cutting groove 28 extend down into the food holder 18 but do not extend completely through to the bottom of the food holder 18.

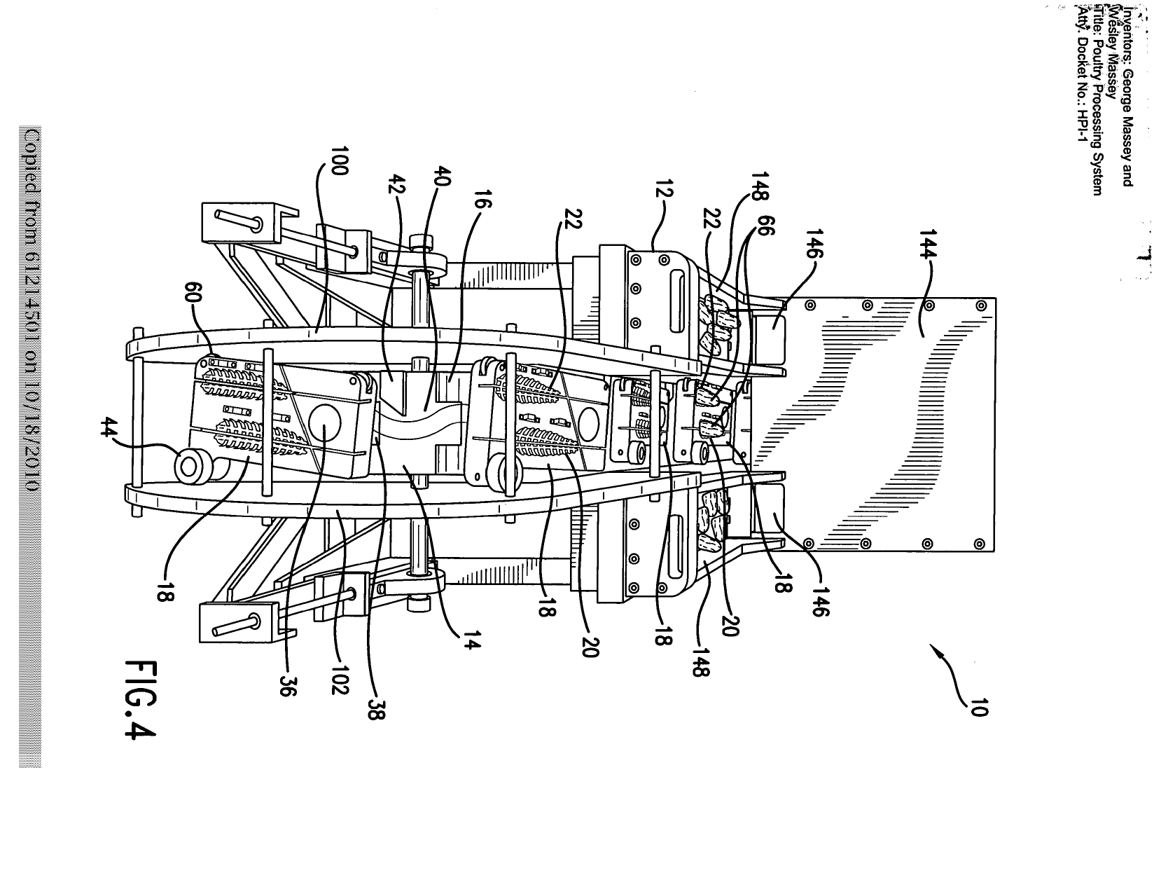

FIG. 3 is a side view of the food holder 18 of FIG. 1 that shows a plurality of bottom projections 98 that are located at the bottom of the food holder 18. The bottom projections 98 may function to provide the food holder 18 with a secure positioning on the conveyor 14. Additionally or alternatively, the bottom projections 98 may act to facilitate relative movement between the food holder 18 and the conveyor 14 during pivoting of the food holder 18. the bottom projections 98 function to reduce friction and to allow for easier cleaning. The guide wheel 44 is shown located at one end of the food holder 18 along the length 50 thereof. The first cutting groove 24 extends down into the food holder 18 a predetermined depth. As shown, the depth of the first cutting groove 24 does not extend to the bottom of the food holder 18. The depths of the first cutting grooves 24, 26 and 28 may be identical or may be different from one another in accordance with various exemplary embodiments.

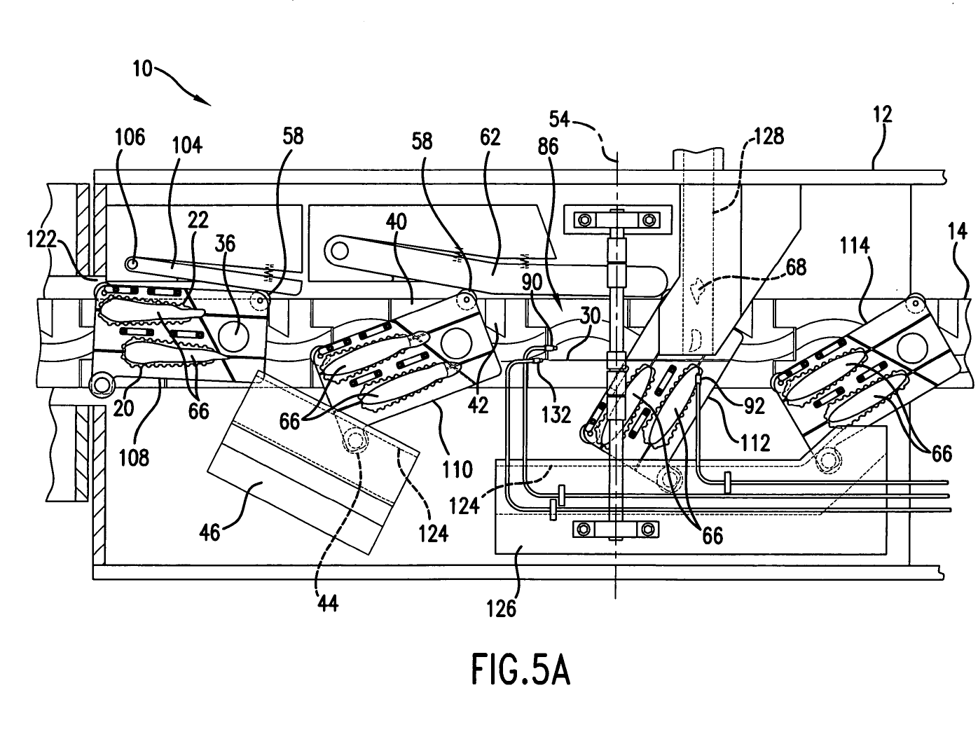

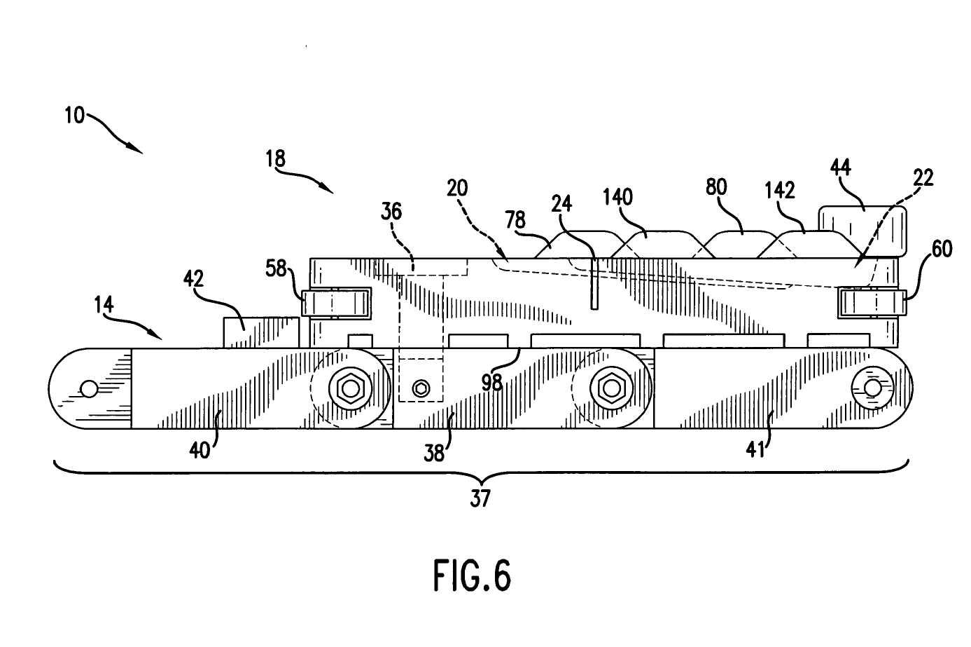

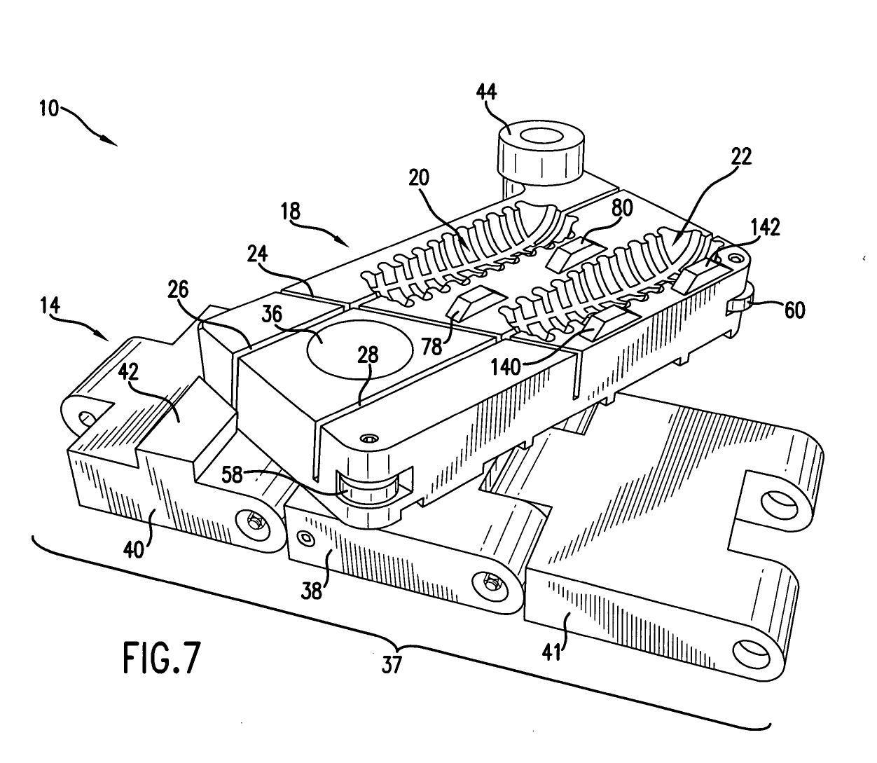

The food holder 18 is pivotally connected to the conveyor 14 as illustrated in FIG. 4. The conveyor 14 is mounted to and is capable of moving with respect to a frame 12. The conveyor 14 may be composed of a series of pivotally connected links generally indicated by reference number 16. FIGS. 6 and 7 illustrate an exemplary embodiment of a food holder 18 attached to a segment 37 of the conveyor 14. The segment 37 is made out of three links 38, 40 and 41. Link 38 is a pivot link 38 to which the food holder 18 is attached by way of the pivot pin 36. A cam link 40 is provided and is attached to the pivot link 38 and located forward of the pivot link 38 in the direction of travel of the conveyor 14. The pivot link 38 includes the stop member 42 that limits rotational movement of the food holder 18. A spacer link 41 is also included in segment 37 and is attached to the pivot link 38 rearward of the pivot link 38 in the direction of travel of the conveyor 14. The spacer link 14 functions to increase the size of the segment 37 so that the proper spacing of various food holders 18 can be maintained. The links 38, 40 and 41 are attached to one another through the use of pivot pins that are disposed perpendicular to the axis of the pivot pin 36. As such, the links 38, 40 and 41 are capable of pivoting with respect to one another as shown for example in FIG. 4. Multiple segments 37 can be attached to one another to form the length of the conveyor 14 and can all be configured in a manner similar to one another. As such, identical segments 37 can be attached to one another in sequence to form conveyor 14.

The links 16 can be made out of the same hard plastic material as the food holder 18 so that they will not react with the food holder 18 and to facilitate cleanliness in the specific operating environment. However, it is to be understood that the links 16 can be constructed out of various materials in accordance with certain exemplary embodiments. The links 16 may each include an arm that extends between a pair of opposed arms of a successive link. The arms are connected to one another through the use of a pivot pin so that the successive links 16 can be connected to yet rotate relative to one another about their pivoted connections. The pivot connection between the links 16 may be made so that they are loose in the side to side direction so as to allow the conveyor 14 to be able to be capable of negotiating curves in specific desired applications.

The food holder 18 is pivotally connected to a pivot link 38 through the use of the pivot pin 36. As shown, the frame 12 includes a pair of guide tracks 100 and 102 that are spaced a distance apart with the conveyor 14 located therebetween. The food holder 18 is likewise located between the guide tracks 100 and 102. The guide wheel 44 and the side roller 60 engage and roll along the guide tracks 100 and 102 in order to ensure smooth movement and accurate positioning of the food holder 18 along and with respect to the frame 12.

Cam link 40 is attached to pivot link 38 and is located forward of pivot link 38 in the traveling or forward direction of the conveyor 14. Cam link 40 includes a stop member 42 on its upper surface. Stop member 42 has an angled surface that is configured for being engaged by the food holder 18 when pivoted about pivot link 38. The stop member 42 functions to limit the rotational range of the food holder 18 about the conveyor 14 as will be momentarily discussed. The conveyor 14 is illustrated as a continuous loop conveyor 14 such that it moves through the processing zone of the system 10 and then moves back underneath the processing zone to the location illustrated in FIG. 4 to once again enter the processing zone. It is to be understood that the conveyor 14 can be variously configured in accordance with other exemplary embodiments. For example, the conveyor 14 need not move back under the processing zone but may instead be moved from a different station to the system 10 and then out of the system 10 to a still further different processing station. Meat 66, which in the illustrated embodiments may be chicken tenders 66, is located in both the first meat depression 20 and the second meat depression 22 of the food holder 18 at some point before entering the processing zone of the system 10. The chicken tenders 66 may be manually or automatically located within the first and second meat depressions 20 and 22. Meat 66 may be located in a meat hopper 144 and can exit therefrom through exits 146 into meat trays 148.

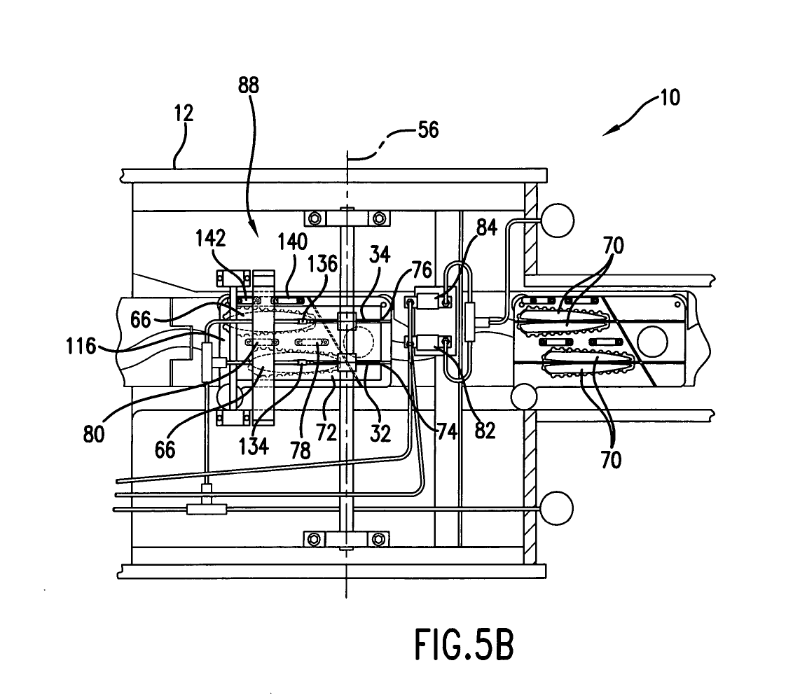

The processing zone of the system 10 is illustrated in FIG. 5 which shows a top view of the components of the system 10 within the frame 12. During use, a cover is located on top of the components illustrated in FIG. 5 in order to maintain cleanliness and to prevent injury from cutting blades due to automatic cutting of the meat 66. The cover has been removed in FIG. 5 to illustrate the various stages of the process. The meat 66 on the food holder 18 initially enters the processing zone at the left side of FIG. 5 from the area of the system 10 previously described and shown with reference to FIG. 4. As shown in FIG. 5, there are a plurality of food holders 18 carried by the conveyor 14. All of the food holders 18 may be formed in an identical manner in accordance with certain exemplary embodiments. The various food holders 18 are designated with different reference numbers in FIG. 5 in order to discuss the particular stages of transport and operation in system 10.

As shown in FIG. 5, food holder 108 enters the processing zone of system 10 through door 122. Food holder 108 is arranged so that the second and third cutting grooves 26 and 28 are generally aligned in the forward direction of travel of the conveyor 14. A spring loaded arm 104 is located to the side of the food holder 108 and is pivotally engaged to frame 12 through a pivot pin 106. The spring loaded arm 104 is biased towards the conveyor 14 so as to engage the side roller 58 of the food holder 108. The spring loaded arm 104 functions to facilitate a smooth transition of the food holder 108 through this portion of the system so as to reduce vibration and movement of the chicken tenders 66 carried by the food holder 108 in addition to assisting with positioning of the food holder 108. The spring loaded arm 104 may, in some alternate embodiments, include a sensor that can be actuated through a predetermined degree of depression of the spring loaded arm 104 so as to alert the system of the presence of the food holder 108 at this location in the process. Although shown as having a spring loaded arm 104, it is to be understood that the spring loaded arm 104 need not be present in other exemplary embodiments. A cam mechanism may be employed instead of the spring loaded arm 104, or a wall may simply be present instead of the spring loaded arm in accordance with other exemplary embodiments.

Continued movement of the conveyor 14 causes the food holder 18 to be advanced to the next, subsequent position illustrated with reference number 110. As shown, food holder 110 is moved off of the spring loaded arm 104. The guide wheel 44 is captured by a guide member 46 that is mounted in a stationary position with respect to the frame 12. Guide member 46 has a ridge 124 that is engaged by the guide wheel 44 of the food holder 110. Ridge 124 extends at an angle to and away from the path of the conveyor 14 thus causing the guide wheel 44 to roll thereon at the same angle away from the path of conveyor 14. Movement of the guide wheel 44 along the guide member 46 thus causes the food holder 110 to be pivoted with respect to the conveyor 14 about pivot pin 36. In such an orientation, the second and third cutting grooves 26 and 28 are positioned at an angle to the path of travel of the conveyor 14. Continued movement of the food holder 18 past the location shown at reference number 110 causes the guide wheel 44 to exit the guide member 46 and be subsequently captured by a second ridge 126 of a second guide member 128.

After leaving the area designated by reference number 110, the food holder 18 enters a first cutting station 86 of the system 10 that is designated by reference number 112. A spring loaded arm 62 is located to the side of the conveyor 14 and is spring loaded so as to be biased toward the conveyor 14. The side roller 58 of the food holder 18 engages the spring loaded arm 62 and rolls thereon. The biasing of the spring loaded arm 62 may function to help hold a side of the food holder 18 so as to prevent or minimize vibration or movement of the food holder 112 when transported or when the meat 66 is cut at the first cutting station 86. The spring loaded arm 62 assists in the positioning of the food holder 112 in the desired location. Although described as having a spring loaded arm 62, it is to be understood that the spring loaded arm 62 need not be present in accordance with other exemplary embodiments. For example, instead of being a spring loaded arm 62, this portion of the system may be a wall that has a hooked or bent area without any biasing member that can engage the side roller of the food holder 18.

Upon entering the first cutting station 86, the guide wheel 44 is captured by the second guide member 128 thus causing the food holder 112 to be pivoted about the conveyor 14 to a position such that the first cutting groove 24 is aligned generally in the same direction of travel as the conveyor 14. The food holder 112 may be pivoted about the conveyor 14 until it contacts the stop member 42 of the conveyor 14. The stop member 42 thus assures the food holder 112 is positioned at a desired location with respect to the conveyor 14 and also functions to acts as a pressure point to help hold the food holder 112 in position during the cutting operation. The first cutting station 86 has a first automatic cutting blade 30 that is capable of cutting the chicken tenders 66. The first automatic cutting blade 30 may be a circular cutting blade and may rotate about an axis of rotation 54. The axis of rotation 54 may be perpendicular to the direction of travel of the conveyor 14. The first automatic cutting blade 30 can be rotationally mounted to the frame 12 through bearing connections that are attached to the frame 12.

The first cutting groove 24 is aligned with the first automatic cutting blade 30 so that movement of the food holder 112 past the first automatic cutting blade 30 causes a portion of the first automatic cutting blade 30 to be received within the first cutting groove 24. Chicken tenders 66 carried by the food holder 112 will be cut by the first automatic cutting blade 30 as the food holder 112 is moved past the first automatic cutting blade 30. The first automatic cutting blade 30 functions to cut fat from the chicken tenders 66 and/or to cut the chicken tenders 66 to a desired length thus resulting in cut portions 68 that are removed from the chicken tenders 66 still located in the first and second meat depressions 20 and 22. A steam of water may be directed onto the first automatic cutting blade 30 by way of a first water jet 132 in order to keep the first automatic cutting blade 30 clean and to facilitate cutting of the various chicken tenders 66.

Engagement of the first cam 78 with a first cam sensor 82, as will be momentarily discussed, causes a first air jet 90 to be actuated. Engagement of the third cam 140 causes a second air jet 92 to be actuated, as will be further discussed. Actuation of the first air jet 90 causes the cut portions 68 to be blown from the food holder 112 and to an opening of a first station conduit 128. Actuation of the second air jet 92 causes the cut portions 68 in midair at the opening of the first station conduit 128 to be further directed into the first station conduit 128 for further processing. As such, the direction of the air blast of the first air jet 90 may be at a ninety degree angle to the direction of the air blast of the second air jet 92. Although shown as using first and second air jets 90 and 92 to remove the cut portions 68 from the food holder 112, other mechanisms of removing the cut portions 68 may be employed in accordance with various exemplary embodiments. For example, a cyclone may be used to remove the cut portions 68 and/or the chicken tenders 66. Further, a vacuum may be created in order to pull the cut portions 68 from the food holder 112, or the first station conduit 128 may have a lip or other mechanical member that functions to scrape the cut potions 68 from the food holder 112 as the food holder is moved by the conveyor 14. Further, the first automatic cutting blade 30 can be run continuously or may be started or sped up once chicken tenders 66 are present at the first cutting station 86. The chicken tenders 66 are thus automatically cut at the first cutting station 86 and cut portions 68 are automatically removed therefrom without the need for manual labor.

As shown, the first meat depression 20 is located ahead of the second meat depression 22 when the food holder 112 is located at the first cutting station 86. The chicken tender 66 in the first meat depression 20 is thus cut before the chicken tender 66 in the second meat depression 22. The cut portion 68 from the chicken tender 66 in the first meat depression 20 is hit by the first air jet 90 to be blown from its cut position and is then hit by the second air jet 92 to be directed into the first station conduit 128. Subsequently, the chicken tender 66 in the second meat depression 22 is cut and the cut portion 68 from this chicken tender 66 is hit by an air blast from the first air jet 90 to be directed from its initial position. This cut portion 68 from the chicken tender of the second meat depression 22 is then hit by an air blast from the second air jet 92 to be directed into the first station conduit 128. The actual cutting of the cut portion 68 from the chicken tender 66 in the second meat depression 22 may occur before, after or simultaneously with the air blast from the second air jet 92 in accordance with various exemplary embodiments. The system sequences the firing of the first air jet 90 and the second air jet 92 upon sensing of the first cam 78, second cam 80, third cam 140 and fourth cam 142 of a different food holder 116 that is at a second cutting station 88 as will be further discussed.

After fat and other portions are cut from the chicken tenders 66 at the first cutting station 86, the food holder 18 is transported to the position indicated by reference number 114. Here, the guide wheel 44 is still contained within the second guide member 126. However, the ridge 124 of the second guide member 126 is directed back towards the conveyor 14 so that continued movement of the conveyor 14 causes the guide wheel 44 to travel along the ridge 124 so that the food holder 114 is pivoted back towards the conveyor 14. In this manner, the second and third cutting grooves 26 and 28 are positioned so as to be closer in alignment with the direction of travel of the conveyor 14 than they were previously when located at the first cutting station 86.

The frame 12 has a funnel arrangement when approaching a second cutting station 88 such that the side walls of frame 12 on either side of the food holder 18 funnel in towards one another. This arrangement functions to pivot the food holder 18 with respect to the conveyor 14 so that the second and third cutting grooves 26 and 28 are arranged along the direction of travel of the conveyor 14. Upon entering the second cutting station 88, the food holder 16 is located at the position indicated by reference number 116. The guide wheel 44, side roller 58 and side roller 60 may thus function to lock the food holder 18 in place for the second cutting station 88. The guide wheel 44 is no longer constrained by the second guide member 126 when the food holder 116 is at the second cutting station 88. However, other exemplary embodiments are also possible in which the guide wheel 44 is constrained by the second guide member 126 when located at the second cutting station 88.

The second cutting station 88 has a second automatic cutting blade 32 and a third automatic cutting blade 34 that share a common axis of rotation 56. The axis of rotation 56 may be parallel to the axis of rotation 54 of the first automatic cutting blade 30. The axis of rotation 54 may be perpendicular to the direction of travel of the conveyor 14. The second and third automatic cutting blades 32 and 34 can be rotationally mounted through the use of bearing mounts to the frame 12. The second cutting station 88 has a cutting plate 72 that is mounted to the frame 12 and is located above the food holder 116. The mounting of the cutting plate 72 is pivotal in nature so that the cutting plate 72 can rotate about its connection and hence move in a generally upwards and downwards direction with respect to the frame 12. The application of force necessary to move the cutting plate 72 upwards can be imparted through contact by the chicken tenders 66 carried by the food holder 116. However, it is to be understood that other exemplary embodiments are possible in which the cutting plate 72 does not pivotally rotate with respect to the frame 12 and is hence a stationary member.

The second automatic cutting blade 32 extends through an opening 74 in the cutting plate 72. In a similar manner, an opening 76 is present in the cutting plate 72 so that the third automatic cutting blade 34 can extend therethrough. The food holder 116 is positioned so that the second automatic cutting blade 32 is aligned with the second cutting groove, and the food holder 116 is positioned so that the third automatic cutting blade 34 is in alignment with the third cutting groove 28. Movement of the food holder 116 through the second cutting station 88 causes a portion of the second automatic cutting blade 32 to be received within the second cutting groove, and causes a portion of the third automatic cutting blade 34 to be received within the third cutting groove 28. The second and third automatic cutting blades 32 and 34 cut the chicken tenders 66 located in the first and second meat depressions 20 and 22 in half to result in cut chicken tenders 70 upon traversing through the second cutting station 88. The chicken tenders 66 are held securely in place between the food holder 116 on one side and the cutting plate 72 on the opposite side so that the forces imparted thereon through cutting by the second and third automatic cutting blades 32 and 34 do not cause the chicken tenders 66 to be pushed off of the food holder 116.

The cutting plate 72 is mounted to the frame 12 by a mount 138. Mount 138 may be pivotally attached to the frame 12 so that the cutting plate 72 may pivot with respect to the frame 12. However, in other arrangements, the mount 138 may be stationary with respect to the frame 12 so that the cutting plate 72 does not move with respect to the frame 12. In accordance with other exemplary embodiments, the mount 138 may be biased towards the conveyor 14 and can be pushed upwards through forces applied by the chicken tenders 66 when passing under and against the cutting plate 72. As the chicken tenders 66 will all not be of an identical size, a pivoting and/or biased cutting plate 72 may be useful in accommodating variously sized chicken tenders 66 so that oversized chicken tenders 66 will not jamb the system 10 or fall off of the food holder 116. Further, a biased cutting plate 72 may assist in ensuring that the cutting plate 72 is always pressed against the chicken tenders 66 when cut by the second and third automatic cutting blades 32 and 34. However, as previously stated, the cutting plate 72 need not be biased and may be stationary with respect to frame 12 in accordance with certain exemplary embodiments. The cutting plate 72 can extend from the mount 138 so as to be oriented at an angle to the conveyor 14. In this regard, the cutting plate 72 may extend downwards and towards the conveyor 14 in the direction of travel of the conveyor 14. This downward orientation of the cutting plate 72 may assist in the positioning of the chicken tenders 66 between the cutting plate 72 and the food holder 116 as it results in a funneling mechanism. However, it is to be understood that other exemplary embodiments are possible in which the cutting plate 72 is not oriented towards the conveyor 14 but is instead aligned in a generally parallel orientation with respect to the conveyor 14 and is not angled thereto.

A second water jet 134 is mounted to the frame 12 and directs a stream of water onto the second automatic cutting blade 32 in order to keep the cutting blade clean to facilitate cutting of the chicken tenders 66. A third water jet 136 is also present and functions in a similar manner with respect to the third automatic cutting blade 34.

A first cam sensor 82 and a second cam sensor 84 are mounted to the frame 12 at a position immediately downstream of the cutting plate 72. The first cam sensor 82 is configured for engaging the first cam 78 in order to sense the presence of the food holder 116. Sensing of the first cam 78 by the first cam sensor 82 causes the first air jet 90 to actuate in order to remove the cut portion 68 of the chicken tender 66 from the first meat depression 20 of the food holder 112 at the first cutting station 86. As such, the system is organized so that sensing of the positioning of the food holder 116 at a forward location along the conveyor 14 causes removal of the cut portion 68 from a food holder 112 located rearward along the conveyor 14 in the direction of travel of the conveyor 14. An additional food holder 114 is located between the two timed and sequenced food holders 112 and 116. However, it is to be understood that the timed and sequenced food holders may be subsequent to one another or may be separated by any number of food holders in accordance with various exemplary embodiments.

A second cam sensor 84 is also mounted to the frame 12 and is capable of engaging the third cam 140 on the food holder 116 in order to sense the presence and position of the food holder 116. Sensing of the third cam 140 by the second cam sensor 84 causes the second air jet 92 to actuate in order to direct the cut portion 68 of the chicken tender 66 from the first meat depression 20 into the first station conduit 128. Continued movement of the food holder 116 causes the second cam 80 to come into engagement with the first cam sensor 82. The first cam sensor 82 senses the second cam 80 and causes the first air jet 90 to actuate in order to blast the cut portion 68 of the chicken tender 66 in the second meat depression 22. Further movement of the food holder 116 causes the fourth cam 142 to come into engagement with the second cam sensor 84. The second cam sensor 84 causes the second air jet 92 to actuate in order to direct the cut portion 68 of the chicken tender 66 from the second meat depression 22 into the first station conduit 128. As such, the cam sensors 82 and 84 detect the presence of a food holder 116 so that cut portions 68 of a subsequent food holder 112 are removed therefrom.

Once the food holder 116 moves past the first and second cam sensor 82 and 84 and exits the second cutting station 88, the cut chicken tenders 70 may be removed. Removal of the cut chicken tenders 70 from the food holder 116 may be done by hand or may be performed through an automatic process. For example, air jets (not shown) can be actuated in order to force the cut chicken tenders 70 from the first and second meat depressions 20 and 22 and into a removal conduit (not shown). In accordance with other exemplary embodiments, the cut chicken tenders 70 can be pulled into a removal conduit (not shown) through the use of a vacuum, cyclone ,or through the use of a mechanical device such as an arm that engages and transfers the cut chicken tenders 70. In accordance with another exemplary embodiment, the food holder 116 leaves the processing zone of the system and is pulled by conveyor 14 into an inverted position. Cut chicken tenders 70 carried by the food holder 116 may thus fall off of the food holder 116 at some point during inversion of the food holder 116 due to gravity and be collected for subsequent processing or packaging. The conveyor 14 can continue so that the food holder 116 moves under the processing zone in the opposite direction to thus assume the initial position illustrated in FIG. 4. However, it is to be understood that the system 10 can be variously configured so that the conveyor 14 does not loop back under the processing zone but instead continues onto an additional station for further processing once leaving the second cutting station 88.

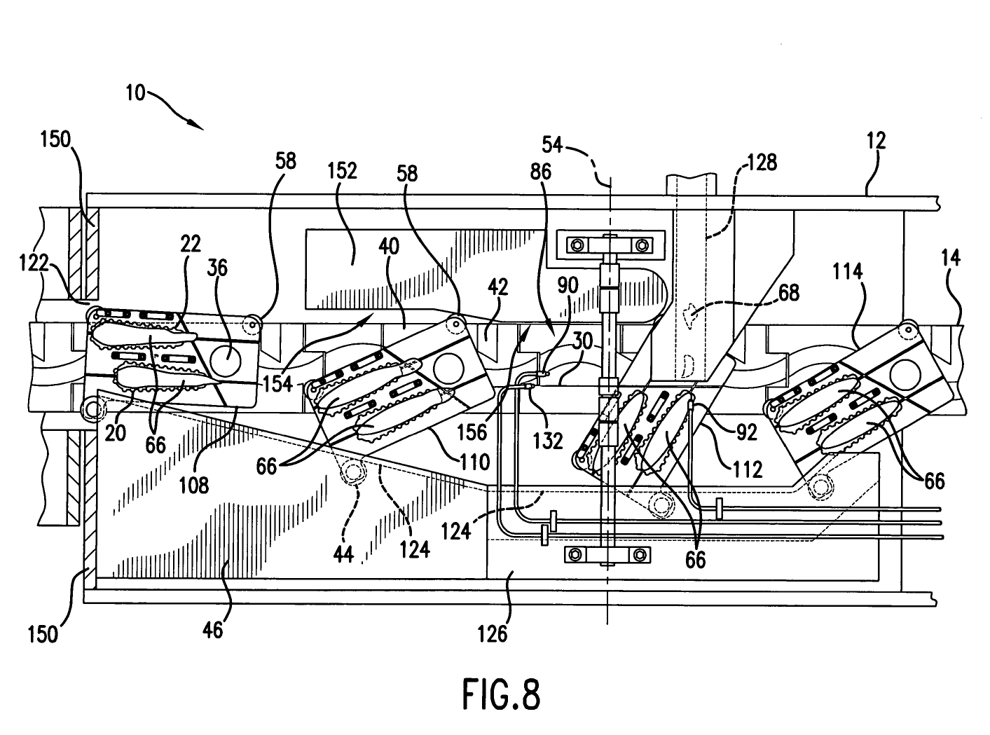

An alternative exemplary embodiment of a system 10 is illustrated in FIG. 8. The system 10 includes a guide member 46 that extends from a wall 150 to the second guide member 126. The guide member 46 has an angled portion that defines a ridge 124 that likewise extends from the wall 150 to the second guide member 126. The ridge 124 may thus catch the guide wheel 44 of the food holder 18 as it emerges past wall 150. The ridge 124 functions to hold and rotate the food holder 18 as it is pulled along by conveyor 14. The spring loaded arms 62 and 104 of the exemplary embodiment illustrated in FIG. 5A are replaced with a side section 152 in the exemplary embodiment of FIG. 8. The side section 152 is a stationary member and does not have portions that are urged towards the food holder 18. The side roller 58 engages an outboard portion 154 of the side section 152. Engagement of the side roller 58 functions to steady and properly locate the food holder 18 as it is pulled by conveyor 14. The outboard portion 154 translates into an inboard portion 156 in the transport direction of the conveyor 14.

The transition from outboard portion 154 to inboard portion 156 may be via a single angled portion or may be via multiple stepped portions. The inboard portion 156 is closer to the pivot pin 36 of the food holder 18 than the outboard portion 154. The difference in inboard/outboard distance between the inboard portion 156 and outboard portion 154 functions to appropriately hold and orient the food holder 18 during transport by conveyor 14. The side section 152 may extend from the wall 150 to the first cutting station 86 so that the side roller 58 engages the side section 152 once it emerges from the wall 150. Alternatively, the side section 152 can be arranged so that it is spaced from the wall 150 so that the side roller 58 does not engage the side section 152 upon emerging from the wall 150 but instead travels some distance in the forward direction of the conveyor 14 before encountering and engaging the outboard portion 154 of the side section 152. The other features of the system may be the same as shown and described with respect to FIG. 5A. Further, downstream sections of the system 10 from those illustrated in FIG. 8 may be the same as those described with reference to FIG. 5B and a repeat of this information is not necessary.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A system for processing meat, comprising:
a plurality of links attached to one another to form a conveyor;
a food holder carried by the conveyor, wherein the food holder defines a meat depression for use in holding meat therein, wherein the food holder defines a first cutting groove, wherein the food holder defines a second cutting groove, wherein the first cutting groove and the second cutting groove intersect one another;
a first automatic cutting blade configured for being at least partially received within the first cutting groove in order to automatically cut the meat; and
a second automatic cutting blade configured for being at least partially received within the second cutting groove in order to automatically cut the meat;
wherein the food holder is configured to be positioned with respect to the conveyor so that the first automatic cutting blade is aligned with the first cutting groove to be at least partially received therein, and wherein the food holder is configured to be positioned with respect to the conveyor so that the second automatic cutting blade is aligned with the second cutting groove to be at least partially received therein.

2. The system as set forth in claim 1, wherein one of the links is a pivot link to which the food holder is pivotally attached so that the food holder is capable of pivoting with respect to the conveyor, wherein one of the links is a cam link that is pivotally attached to the pivot link and has a stop member capable of being engaged by the food holder in order to limit the pivotal range of the food holder with respect to the conveyor, wherein one of the links is a spacer link that is pivotally attached to the pivot link.

3. The system as set forth in claim 1, wherein the food holder has a guide wheel, and further comprising a guide member that is configured for being engaged by the guide wheel of the food holder to effect repositioning of the food holder with respect to the conveyor.

4. The system as set forth in claim 1, wherein the food holder defines a second meat depression for use in holding meat therein, wherein the first meat depression and the second meat depression are configured for holding chicken tenders therein, wherein the first cutting groove extends across substantially the width of the food holder and does not intersect the first meat depression and the second meat depression, wherein the second cutting groove extends across substantially the length of the food holder and intersects the midpoint of the first meat depression, and wherein the food holder defines a third cutting groove that intersects the first cutting groove and does not intersect the second cutting groove, wherein the third cutting groove extends across substantially the length of the food holder and intersects the midpoint of the second meat depression, wherein the first cutting groove is oriented at a non-perpendicular angle to both the second cutting groove and the third cutting groove.

5. The system as set forth in claim 4, further comprising a third automatic cutting blade configured for being at least partially received within the third cutting groove in order to automatically cut the meat, wherein the first automatic cutting blade, the second automatic cutting blade and the third automatic cutting blade are circular blades, wherein the second automatic cutting blade and the third automatic cutting blade share a common axis of rotation, wherein the axis of rotation of the first cutting blade is parallel to the axis of rotation of the second and third cutting blades.

6. The system as set forth in claim 1, further comprising a spring loaded arm that is capable of being pivoted with respect to a frame, wherein the food holder has at least one side roller that is capable of engaging the spring loaded arm, wherein the spring loaded arm functions to position the food holder with respect to the conveyor.

7. The system as set forth in claim 1, further comprising a cutting plate that is configured for engaging meat held by the food holder such that the meat is located between the cutting plate and the food holder and is held in place when being cut by the second automatic cutting blade, wherein the second automatic cutting blade extends through the cutting plate.

8. The system as set forth in claim 1, further comprising:
a first cam sensor;
a second cam sensor;
a second food holder;
wherein the food holder has a first cam, a second cam, a third cam and a fourth cam, wherein the sensing of the first cam by the first cam sensor and the sensing of the third cam by the second cam sensor causes actuation of a first air jet and a second air jet to cause a cut portion of meat carried by the second food holder to be removed from the second food holder and directed into a conduit, and wherein the sensing of the second cam by the first cam sensor and the sensing of the fourth cam by the second cam sensor causes actuation of the first air jet and the second air jet to cause a second cut portion of meat carried by the second food holder to be removed from the second food holder and directed into the conduit.

9. A system for processing food, comprising:
a conveyor that is capable of moving;
a food holder carried by the conveyor, wherein the food holder is configured for carrying food thereon, wherein the food holder is pivotally connected to the conveyor so as to be capable of pivoting with respect to the conveyor;
a first cutting station, wherein the conveyor is capable of transporting the food holder to the first cutting station, wherein the first cutting station has a first automatic cutting blade, wherein the first automatic cutting blade is configured for cutting the food on the food holder, and wherein a portion of the cut food is removed from the first cutting station by one or more blasts of air; and
a second cutting station, wherein the conveyor is capable of transporting the food holder to the second cutting station after transport to the first cutting station, wherein the second cutting station has a second automatic cutting blade, wherein the second automatic cutting blade is configured for cutting the food on the food holder, wherein the food holder is pivoted at a different position with respect to the conveyor when at the first cutting station as opposed to when at the second cutting station.

10. The system as set forth in claim 9, wherein the conveyor has a plurality of links that are pivotally connected to one another, wherein one of the links is a pivot link to which the food holder is pivotally attached so that the food holder is capable of pivoting with respect to the conveyor, wherein one of the links is a cam link that is pivotally attached to the pivot link and has a stop member capable of being engaged by the food holder in order to limit the pivotal range of the food holder with respect to the conveyor, wherein one of the links is a spacer link that is pivotally attached to the pivot link.

11. The system as set forth in claim 9, wherein the food holder defines a food depression for use in holding food therein, wherein the food holder defines a first cutting groove and a second cutting groove that intersect one another, wherein the food holder is configured for being positioned with respect to the first automatic cutting blade so that the first automatic cutting blade is at least partially received within the first cutting groove in order to automatically cut the food, wherein the food holder is configured for being positioned with respect to the second automatic cutting blade so that the second automatic cutting blade is at least partially received within the second cutting groove in order to automatically cut the food.

12. The system as set forth in claim 9, wherein the food holder has a guide wheel, and further comprising a guide member that is configured for being engaged by the guide wheel of the food holder to effect pivoting of the food holder with respect to the conveyor.

13. The system as set forth in claim 9, further comprising a spring loaded arm that is capable of being pivoted with respect to a frame, wherein the spring loaded arm is capable of engaging the food holder in order to position the food holder with respect to the conveyor.

14. The system as set forth in claim 9, wherein the second cutting station has a cutting plate that is configured for engaging food carried by the food holder such that the food is located between the cutting plate and the food holder and is held in place when in the second cutting station and when cut by the second automatic cutting blade, wherein the second automatic cutting blade extends through the cutting plate.

15. The system as set forth in claim 9, further comprising a second food holder that has at least one cam, wherein sensing of the cam at the second cutting station causes actuation of one or more blasts of air in order to remove the portion of the cut food at the food holder from the first cutting station.

16. A system for processing meat, comprising:
a frame;
a plurality of links attached to one another to form a conveyor, wherein the conveyor is carried by the frame and is capable of moving with respect to the frame;
a food holder carried by the conveyor, wherein the food holder is configured for carrying meat thereon, wherein the food holder is pivotally connected to the conveyor so as to be capable of pivoting with respect to the conveyor;
a first automatic cutting blade configured for automatically cutting the meat carried by the food holder, wherein the conveyor transports the food holder to the first automatic cutting blade to allow the first automatic cutting blade to automatically cut the meat carried by the food holder;
wherein the food holder is automatically pivoted to a different position with respect to the conveyor after the meat is automatically cut by the first automatic cutting blade;
a second automatic cutting blade configured for automatically cutting the meat carried by the food holder, wherein the conveyor transports the food holder to the second automatic cutting blade to allow the second automatic cutting blade to automatically cut the meat carried by the food holder, wherein the food holder is pivoted at a different position with respect to the conveyor when the meat is cut by the first automatic cutting blade than when the meat is cut by the second automatic cutting blade; and
a cutting plate that is configured for engaging the meat held by the food holder such that when the meat is automatically cut by the second automatic cutting blade the meat is located between the cutting plate and the food holder.

17. The system as set forth in claim 16, wherein the cutting plate is pivotally mounted with respect to the frame such that the cutting plate is capable of pivoting with respect to the frame, and wherein the second automatic cutting blade extends through the cutting plate.

18. The system as set forth in claim 16, wherein the food holder has a guide wheel, and further comprising a guide member mounted to the frame that is configured for being engaged by the guide wheel of the food holder to effect pivoting of the food holder with respect to the conveyor.

19. The system as set forth in claim 16, wherein the food holder defines a meat depression for use in holding meat therein, wherein the food holder defines a first cutting groove and a second cutting groove that intersect one another, wherein the food holder is configured for being positioned with respect to the first automatic cutting blade so that the first automatic cutting blade is at least partially received within the first cutting groove in order to automatically cut the meat, wherein the food holder is configured for being positioned with respect to the second automatic cutting blade so that the second automatic cutting blade is at least partially received within the second cutting groove in order to automatically cut the meat.

20. The system as set forth in claim 16, further comprising:
a first air jet mounted to the frame and configured for blowing a portion of the cut meat from the food holder when cut by the first automatic cutting blade; and
a second air jet mounted to the frame and configured for blowing the portion of the cut meat from the food holder into a first station conduit after being blown by the first air jet.

21. A segment of a conveyor of a food processing system, comprising:
a pivot link having a food holder pivotally attached thereon;
a cam link pivotally attached to the pivot link, wherein the cam link has a stop member located on a surface that is configured for engaging the food holder so as to limit the range of rotation of the food holder; and
a spacer link pivotally attached to the pivot link.
